(19) United States
(12) Patent Application Publication
(10) Pub. No.: US 2026/0348388 A1
(43) Pub. Date: Nov. 5, 2026

(54) TURBOMOLECULAR VACUUM PUMP

(71) Applicant: PFEIFFER VACUUM, Annecy (FR)

(72) Inventors: Alysson Bruno BARBOSA MOREIRA, Annecy Cedex (FR); Pierre-Emmanuel CAVAREC, Annecy Cedex (FR); Cécile CHAVANNE, Annecy Cedex (FR); Nicolas VARENNES, Annecy Cedex (FR)

(73) Assignee: PFEIFFER VACUUM, Annecy (FR)

(21) Appl. No.: 19/485,098

(22) PCT Filed: Apr. 8, 2024
(86) PCT No.: PCT/EP2024/059434

§ 371 Date: Nov. 17, 2025

(30) Foreign Application Priority Data
Jun. 15, 2023 (FR) FR2306111

(51) Int. Cl. F04D 19/04; F04D 29/32; F04D 29/58

(52) U.S. Cl. CPC F04D 19/042; F04D 29/32; F04D 29/582

(57) ABSTRACT

A turbomolecular vacuum pump includes a stator, a rotor to rotate in the stator. The rotor includes at least one stage of blades, an inner cylindrical skirt, and at least one outer cylindrical skirt. The inner and outer cylindrical skirts being coaxial and able to rotate facing respective Holweck stators of the stator. The inner cylindrical skirt is made of a material with a thermal conductivity that is higher than that of the material forming the at least one outer cylindrical skirt. The thickness of the inner cylindrical skirt is greater than the thickness of the outer cylindrical skirt.

### TECHNICAL FIELD

The present invention relates to a turbomolecular vacuum pump.

### BACKGROUND

Generating a high vacuum in a vessel requires the use of turbomolecular vacuum pumps composed of a stator in which a rotor is driven at high speed, for example at more than twenty thousand revolutions per minute.

Some pumping applications require the pumping of high gas throughputs and, in particular, of light gases. In the semiconductor industry and, notably, in EUV lithography methods, process chamber cleaning methods require the pumping of high hydrogen throughputs. This is likewise the case in certain battery-manufacturing methods.

Pumping high hydrogen throughputs can be achieved, in particular, by using turbomolecular vacuum pumps having high compression ratios. For example, pumps are known in the art with three Holweck stages in which the gases to be pumped flow in series. These Holweck stages are formed by Holweck stators interposed between two coaxial cylindrical skirts of the rotor, the gases alternately flowing in opposite axial directions between the skirts and the Holweck stators.

However, in the case of rotors made of aluminum, the diameter of the outer skirt of the rotor is limited, in order to avoid inducing excessive mechanical stress due to centrifugal forces, thereby controlling the associated creep risk.

Another drawback lies in the difficulty of manufacturing the monolithic aluminum rotor because of the small clearance separating the two skirts. The rotor is also relatively heavy, which can lead to significant energy consumption and a longer run-up time.

Rotors are also known in which the cylindrical skirts are made of composite material. It is difficult, however, to keep the rotor temperature low (for example, around a maximum of 50 °C) at the turbomolecular stage, because the heat generated by gas compression and friction is difficult to dissipate, on the one hand by conduction, due to the low thermal conductivity of the skirts, and, on the other hand, by radiation at these temperatures. In addition, control of the magnetic bearings is difficult to achieve for rotors with skirts made of composite material due to their low mass, resulting in a high polar-to-diametral moment of inertia ratio (Iₚ/I_{d}).

There is therefore a need to provide a rotor for a turbomolecular vacuum pump with a high compression ratio, exhibiting good mechanical robustness, and a rotor heating temperature that can be controlled so as not to exceed a few tens of degrees Celsius. There is also a need to improve magnetic-bearing control, in particular to reduce the vibration level of the vacuum pump.

### SUMMARY

An object of the present invention is therefore to provide a turbomolecular vacuum pump that at least partially overcomes the drawbacks of the prior art.

To this end, the invention provides a turbomolecular vacuum pump comprising a stator, a rotor configured to rotate within the stator, the rotor comprising at least one bladed stage, an inner cylindrical skirt, and at least one outer cylindrical skirt, the inner and outer cylindrical skirts being coaxial and configured to rotate opposite respective Holweck stators of the stator, characterized in that the inner cylindrical skirt is made of a material having higher thermal conductivity than the material forming the at least one outer cylindrical skirt.

The higher-thermal-conductivity material of the inner cylindrical skirt promotes heat exchange by conduction, convection, and radiation with the stator. The rotor can thereby be cooled more effectively. The succession of Holweck stages in series therefore makes it possible to achieve high compression ratios, notably to enable the pumping of high hydrogen throughputs while allowing the rotor to be kept at a low temperature.

The vacuum pump may additionally include one or more of the features described below, taken alone or in combination.

The thermal conductivity of the inner cylindrical skirt is, for example, at least ten times greater, for example at least fifty times greater, than the thermal conductivity of the material forming the at least one outer cylindrical skirt.

The inner cylindrical skirt may be metallic, for example made of aluminum.

The at least one outer cylindrical skirt may be made of a composite material. The composite comprises, for example, a thermoset or thermoplastic matrix reinforced with glass or carbon fibers.

The thickness of the inner cylindrical skirt may be greater than the thickness of the outer cylindrical skirt, for example at least twice as great. A greater thickness of the inner cylindrical skirt allows improved heat exchange with the stator and therefore allows the equilibrium temperature to be lowered. The thickness of the inner cylindrical skirt may be between 5 mm and 10 mm. The thickness of the outer cylindrical skirt may be between 2 mm and 5 mm.

The mass density of the higher-thermal-conductivity material, such as aluminum, may be higher than the mass density of the lower-thermal-conductivity material, such as the composite. With a higher mass density and/or a greater thickness, the inner cylindrical skirt contributes moreover to increasing the diametral moment of inertia la than the polar moment of inertia Iₚ, so that the polar-to-diametral moment of inertia ratio (Iₚ/I_{d}) of the rotor decreases. The outer cylindrical skirt has the same effect on the ratio (lighter at the outside) but minimized by the density of the material; therefore, using a material of lower density and/or thickness for the outer cylindrical skirt allows any increase in the ratio to be minimized. The polar and diametral moments of inertia of the rotor can therefore be optimized, the rotor becomes more stable, which allows the vibration level of the vacuum pump to be reduced.

Moreover, the outer cylindrical skirt made of composite material can have a large diameter without creep risk and without an excessive increase in weight. In addition, the rotor is less expensive than a rotor made entirely of aluminum.

According to one embodiment, the stator comprises a dome extending beneath the inner cylindrical skirt, and the vacuum pump includes a cooling device configured to cool the stator and, in particular, the stator dome.

According to one embodiment, the stator comprises an outer sleeve and a coaxial inner sleeve arranged inside the outer sleeve, the Holweck stators being formed by first helical grooves provided in the outer sleeve facing an outer face of the outer cylindrical skirt, by second helical grooves provided in the inner sleeve on an outer face situated facing an inner face of the outer cylindrical skirt, and by third helical grooves provided in the inner sleeve facing the outer face of the inner cylindrical skirt.

According to one embodiment, the rotor further comprises:
a hub, with the at least one bladed stage extending radially from the hub, and
a radial spacer extending from the rim of the inner cylindrical skirt, the inner cylindrical skirt, the at least one bladed stage, the hub, and the annular spacer being formed in one piece.

The outer cylindrical skirt may be adhesively bonded to the periphery of the radial spacer.

The rotor may be radially and axially guided by magnetic bearings.

### BRIEF DESCRIPTION OF THE DRAWINGS

Other advantages and features will become apparent by reading the description of the invention and the attached drawings, in which:

FIG. 1 shows a schematic axial cross-sectional view of an example of a turbomolecular vacuum pump.

FIG. 2 shows a sectional view of the rotor of the turbomolecular vacuum pump in FIG. 1.

In these figures, identical elements bear the same reference signs.

### DETAILED DESCRIPTION

The embodiments that follow are examples. Although the description refers to one or more embodiments, this does not necessarily mean that each reference relates to the same embodiment, or that the features apply only to a single embodiment. Individual features of different embodiments may likewise be combined or interchanged to provide other embodiments without departing from the scope of the invention as defined by the claims.

“Upstream” is understood to mean an element that is located before another with respect to the direction of flow of the gas to be pumped. Conversely, “downstream” is understood to mean an element that is located after another with respect to the direction of flow of the gas to be pumped.

The axial direction of the vacuum pump 1 is defined as the direction parallel to the axis of rotation I-I of the vacuum pump 1.

One element is considered to be located further outwards than another element if it is further from the axis of rotation than the other element. One element is considered to be located further inwards than another element if it is closer to the axis of rotation than the other element.

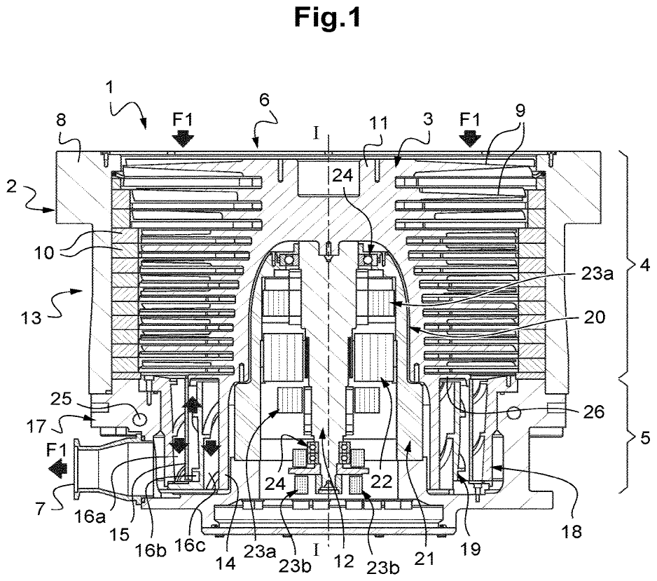

FIG. 1 illustrates an example of an embodiment of a turbomolecular vacuum pump 1.

The turbomolecular vacuum pump 1 comprises a stator 2 in which a rotor 3 is configured to rotate at high speed about the axis, for example at more than twenty thousand revolutions per minute, so as to entrain gases to be pumped along a gas-flow path disposed between the stator 2 and the rotor 3.

The vacuum pump 1 is intended, for example, to evacuate a process chamber in which high hydrogen throughputs may be pumped, such as an EUV lithography process chamber in the semiconductor industry or a battery-manufacturing process chamber.

The turbomolecular vacuum pump 1 is a so-called hybrid pump: it comprises a turbomolecular stage 4 and a molecular drag stage 5 located downstream of the turbomolecular stage 4 in the direction of flow of the pumped gases (indicated by arrows F1 in FIG. 1). The pumped gases enter through the inlet port 6, pass first through the turbomolecular stage 4 and then through the molecular drag stage 5, and are then discharged towards a discharge port 7 of the turbomolecular vacuum pump 1. During operation, the discharge port 7 is connected to a rough-vacuum pump.

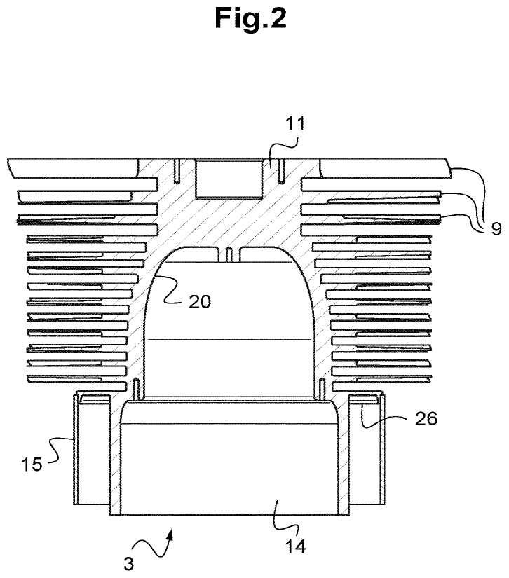

In the turbomolecular stage 4, the rotor 3 comprises at least one bladed stage 9, and the stator 2 comprises at least one vane stage 10. The bladed stages 9 and vane stages 10 are arranged in axial succession along the axis of rotation I-I of the rotor 3 in the turbomolecular stage 4. The rotor 3, for example, comprises more than four bladed stages 9, such as between four and fifteen bladed stages 9 (thirteen in the example shown in FIGS. 1 and 2).

Each bladed stage 9 of the rotor 3 comprises inclined blades that extend in a substantially radial direction from a hub 11 of the rotor 3, which is fastened to a drive shaft 12 of the vacuum pump 1, for example by screwing. The blades are distributed uniformly around the periphery of the hub 11.

Each vane stage 10 of the stator 2 comprises a ring from which inclined vanes extend in a substantially radial direction, distributed uniformly along the inner circumference of the ring. The vanes of a vane stage 10 of the stator 2 interleave between the blades of two successive bladed stages 9 of the rotor 3. The blades 9 of the rotor 3 and the vanes 10 of the stator 2 are inclined so as to guide the pumped gas molecules towards the molecular drag stage 5.

The stator 2 comprises a turbomolecular stator section 13 that receives the at least two vane stages 10. This turbomolecular stator section 13 is open at one end at the inlet port 6 of the vacuum pump 1. It may comprise an annular inlet flange 8 surrounding the inlet port 6 for connecting the vacuum pump 1 to a vessel, the pressure of which is to be reduced.

In the molecular drag stage 5, and as can be seen more clearly in FIG. 2, the rotor 3 further comprises an inner cylindrical skirt 14 and at least one outer cylindrical skirt 15, referred to as Holweck skirts, the inner and outer cylindrical skirts 14, 15 being coaxial, arranged downstream of the at least two bladed stages 9, and configured to rotate opposite respective Holweck stators of the stator 2.

Each skirt 14, 15 is formed by a smooth cylinder that rotates opposite respective Holweck stators formed by helical grooves 16a, 16b, 16c (FIG. 1). The helical grooves 16a, 16b, 16c of each Holweck stator are arranged one above the other. The helical grooves 16a, 16b, 16c allow the pumped gases to be compressed and guided towards a discharge of the vacuum pump 1 provided in the stator 2 and opening at the discharge port 7.

According to one example of an embodiment, the stator 2 comprises an outer sleeve 18 and a coaxial inner sleeve 19 arranged inside the outer sleeve 18. The sleeves 18, 19 are received in a molecular stator section 17 to which they are fastened. The molecular stator section 17 is fastened to, and axially follows, the turbomolecular stator section 13 along the axis of rotation I-I of the rotor 3.

The Holweck stators are formed by first helical grooves 16a provided in the outer sleeve 18 facing an outer face of the outer cylindrical skirt 15, by second helical grooves 16b provided in the inner sleeve 19 on an outer face situated opposite an inner face of the outer cylindrical skirt 15, and by third helical grooves 16c provided in the inner sleeve 19 facing the outer face of the inner cylindrical skirt 14.

A first axial clearance is formed between the annular end of the outer cylindrical skirt 15 and the stator 2 at the sleeves 18, 19, and a second axial clearance is formed between the annular end of the inner sleeve 19 and the rotor 3, between the two skirts 14, 15.

During operation, the gases flow in parallel directions through the succession of Holweck stages located between the smooth walls of the skirts 14, 15 and the helical grooves 16a, 16b, 16c of the sleeves 18, 19, these Holweck stages being connected in series, on the one hand at the annular end of the outer cylindrical skirt 15 and, on the other hand, at the annular end of the inner sleeve 19.

The rotor 3 further comprises an internal bowl 20 (FIG. 2) coaxial with the axis of rotation I-I and arranged opposite a dome 21 of the stator 2, a base of which is fastened to the molecular stator section 17, the dome 21 extending beneath the inner cylindrical skirt 14 and projecting beneath the rotor 3 (FIG. 1). During operation, the rotor 3 rotates within the stator 2 without contact between the internal bowl 20 and the dome 21.

The rotor 3 is driven in rotation within the stator 2 by a motor 22 of the vacuum pump 1. The motor 22 is arranged, for example, in the dome 21 of the stator 2, itself arranged beneath the internal bowl 20 of the rotor 3, with the drive shaft 12 passing through the dome 21 of the stator 2.

The rotor 3 is guided radially and axially by magnetic bearings 23a, 23b and by backup mechanical bearings 24 supporting the drive shaft 12 of the rotor 3, located in the stator 2. For example, there are first radial magnetic bearings 23a supporting and guiding the drive shaft 12 in the dome 21 of the stator 2, second radial magnetic bearings 23a at the top of the dome 21 at a first end of the drive shaft 12, and axial magnetic bearings 23b located at a second end of the drive shaft 12. The active magnetic bearings 23a, 23b allow a rotor 3 to be kept levitated within the magnetic field created.

Other electrical or electronic components may be housed in the dome 21 of the stator 2, such as position sensors.

The vacuum pump 1 may comprise a cooling device 25 for the stator 2, realized, for example, as a hydraulic circuit through which a coolant-such as water, for example at ambient temperature-flows. The cooling device 25 is configured to cool the stator 2, in particular the dome 21, for example by being arranged in the dome 21 or in an element in thermal contact with the dome 21, such as the molecular stator section 17 (FIG. 1), so as to be able to continuously cool the components it contains, namely the bearings 23a, 23b, 24, the motor 22, and other electrical or electronic components, to allow their operation.

The inner cylindrical skirt 14 is made of a material having higher thermal conductivity than the material forming the at least one outer cylindrical skirt 15. The thermal conductivity of the inner cylindrical skirt 14 is, for example, at least ten times, or even at least fifty times, greater than the thermal conductivity of the material forming the at least one outer cylindrical skirt 15.

If the rotor 3 comprises an inner cylindrical skirt 14 and multiple coaxial outer cylindrical skirts 15, all of the outer cylindrical skirts 15 may be made of a material having lower thermal conductivity than the material forming the inner cylindrical skirt 14.

The inner cylindrical skirt 14 is, for example, metallic, for example made of aluminum. It is also possible to coat the inner cylindrical skirt 14, particularly the inner face, with a thermally conductive coating, such as a DLC (diamond-like carbon) coating.

The outer cylindrical skirt 15 is, for example, made of a composite material (with an organic matrix). The composite comprises, for example, a thermoset matrix, such as a resin, e.g., an epoxy resin (also called polyepoxide or epoxy polymer), or a thermoplastic matrix, reinforced with glass or carbon fibers. It is also possible to coat the outer cylindrical skirt 15, particularly the inner face, with a thermally conductive coating, such as a DLC (diamond-like carbon) coating.

The rotor 3 comprises, for example, an inner cylindrical skirt 14 made of aluminum and an outer cylindrical skirt 15 made of a carbon-fiber/epoxy composite. The thermal conductivity of aluminum (2.3×10⁻⁵ °C⁻¹) is markedly higher than that of a carbon-fiber/epoxy composite (2.0×10⁻⁷ °C⁻¹).

According to one embodiment, the hub 11, the at least one bladed stage 9 extending radially from the hub 11, the inner cylindrical skirt 14, and a radial spacer 26 extending radially from the rim of the inner cylindrical skirt 14, between the inner cylindrical skirt 14 and the at least one bladed stage 9, are formed in one piece, for example of a metallic material such as aluminum. The outer cylindrical skirt 15 may be fastened on the periphery of the radial spacer 26, for example by adhesive bonding.

The higher-thermal-conductivity material of the inner cylindrical skirt 14 allows heat exchange by conduction, convection, and radiation with the cooled dome 21 located beneath the inner cylindrical skirt 14 to be promoted. The inner cylindrical skirt 14, but also the bladed stages 9 of the rotor 3, can therefore be cooled more effectively.

The thickness of the inner cylindrical skirt 14 may be between 5 mm and 10 mm, for example 7 mm. The thickness of the outer cylindrical skirt 15 may be between 2 mm and 5 mm, for example 4 mm. It is anticipated, for example, that the thickness of the inner cylindrical skirt 14 may be greater than the thickness of the outer cylindrical skirt 15, for example at least twice as great. A greater thickness of the inner cylindrical skirt 14 allows heat exchanges with the stator 2 to be promoted and therefore lowers the equilibrium temperature. The thickness of the inner cylindrical skirt 14 may be increased, and the thickness of the cylindrical skirt 15 may be decreased, as there is a reduction in diameter of the skirts 14, 15 owing to the reduction in mechanical stresses.

By their geometry, turbomolecular vacuum pumps 1 exhibit polar-to-diametral moment of inertia ratios (Iₚ/I_{d}) of the rotor 3 below one, and it is desirable to reduce this ratio as far as possible, in order to improve control of the active magnetic bearings (AMB) and to lower the vibration level of the vacuum pump 1.

The density of the higher-thermal-conductivity material, such as aluminum, may be higher than the density of the lower-thermal-conductivity material, such as the composite.

With a higher density and/or a greater thickness, the inner cylindrical skirt 14 contributes more to increasing the diametral moment of inertia I_{d} (since the mass is increased further from the center of gravity) than to increasing the polar moment of inertia Iₚ (owing to its smaller diameter), so that the polar-to-diametral moment of inertia ratio (Iₚ/I_{d}) of the rotor 3 decreases. The outer cylindrical skirt 15 has the same effect on the ratio (lighter on the outside), but this is mitigated by the material density; hence, using a material of lower density and/or thickness for the outer cylindrical skirt 15 allows any increase in the ratio to be minimized.

Moreover, the outer cylindrical skirt 15 made of composite material can have a large diameter without creep risk and without an excessive increase in weight. Moreover, the rotor 3 is less costly than a rotor made entirely of aluminum.

The series succession of Holweck stages therefore makes it possible to achieve high compression ratios, enabling, in particular, the pumping of high hydrogen throughputs, while keeping the rotor 3 at a low temperature. In addition, the polar and diametral moments of inertia of the rotor are optimized; the rotor 3 becomes more stable, which reduces the vibration level of the vacuum pump 1.

1-14. (canceled)

15. A turbomolecular vacuum pump, comprising:
a stator, a rotor configured to rotate within the stator, the rotor comprising at least one bladed stage, an inner cylindrical skirt, and at least one outer cylindrical skirt, the inner and outer cylindrical skirts being coaxial and configured to rotate opposite respective Holweck stators of the stator, the inner cylindrical skirt being made of a material having higher thermal conductivity than a material forming the at least one outer cylindrical skirt, wherein a thickness of the inner cylindrical skirt is greater than a thickness of the outer cylindrical skirt.

16. The vacuum pump as claimed in claim 15, wherein the thermal conductivity of the inner cylindrical skirt is at least ten times greater than the thermal conductivity of the material forming the at least one outer cylindrical skirt.

17. The vacuum pump as claimed in claim 15, wherein the thermal conductivity of the inner cylindrical skirt is at least fifty times greater than the thermal conductivity of the material forming the at least one outer cylindrical skirt.

18. The vacuum pump as claimed in claim 15, wherein the inner cylindrical skirt is metallic.

19. The vacuum pump as claimed in claim 15, wherein the inner cylindrical skirt is made of aluminum.

20. The vacuum pump as claimed in claim 15, wherein the at least one outer cylindrical skirt is made of a composite material.

21. The vacuum pump as claimed in claim 20, wherein the composite comprises a thermoset or thermoplastic matrix reinforced with glass or carbon fibers.

22. The vacuum pump as claimed in claim 15, wherein the thickness of the inner cylindrical skirt is at least twice the thickness of the outer cylindrical skirt.

23. The vacuum pump as claimed in claim 15, wherein the thickness of the inner cylindrical skirt is between 5 mm and 10 mm.

24. The vacuum pump as claimed in claim 15, wherein the thickness of the outer cylindrical skirt is between 2 mm and 5 mm.

25. The vacuum pump as claimed in claim 15, wherein the stator comprises a dome extending beneath the inner cylindrical skirt, and the vacuum pump includes a cooling device configured to cool the stator.

26. The vacuum pump as claimed in claim 25, wherein the cooling device is configured to cool the dome of the stator.

27. The vacuum pump as claimed in claim 15, wherein the stator comprises an outer sleeve and a coaxial inner sleeve arranged within the outer sleeve, the Holweck stators being formed by first helical grooves provided in the outer sleeve facing an outer face of the outer cylindrical skirt, by second helical grooves provided in the inner sleeve on an outer face situated facing an inner face of the outer cylindrical skirt, and by third helical grooves provided in the inner sleeve facing the outer face of the inner cylindrical skirt.

28. The vacuum pump as claimed in claim 15, wherein the rotor further comprises:
a hub, the at least one bladed stage extending radially from the hub; and
a radial spacer extending from a rim of the inner cylindrical skirt;
the inner cylindrical skirt, the at least one bladed stage, the hub, and the radial spacer being formed in one piece.

29. The vacuum pump as claimed in claim 28, wherein the outer cylindrical skirt is adhesively bonded to a periphery of the radial spacer.

30. The vacuum pump as claimed in claim 15, wherein the rotor is guided radially and axially by magnetic bearings.
